(19) United States
(12) Patent Application Publication
(10) Pub. No.: US 2009/0097830 A1
(43) Pub. Date: Apr. 16, 2009

(54) MOTOR DRIVE DEVICE PROVIDED WITH DISTURBANCE LOAD TORQUE OBSERVER

(75) Inventors: Yasusuke IWASHITA, Minamitsuru-gun (JP); Tadashi OKITA, Minamitsuru-gun (JP); Junichi TEZUKA, Minamitsuru-gun (JP); Kenta YAMAMOTO, Minamitsuru-gun (JP)

Correspondence Address: LOWE HAUPTMAN HAM & BERNER, LLP, 1700 DIAGONAL ROAD, SUITE 300, ALEXANDRIA, VA, 22314, US

(73) Assignee: FANUC LTD, Minamitsuru-gun (JP)

(21) Appl. No.: 12/203,333

(22) Filed: Sep. 3, 2008

(30) Foreign Application Priority Data
Oct. 11, 2007 (JP) 2007-265732

(51) Int. Cl. H02P 7/00

(52) U.S. Cl. 388/800

(57) ABSTRACT

A motor drive device (10) including a velocity command preparing means for preparing a velocity command value of a motor (20), a velocity detecting means (21) for detecting a velocity of the motor, a torque command value preparing means (12) for preparing a torque command value of a torque applied to the motor based on the velocity command value and a velocity detection value, and a disturbance load torque estimating means (18) for estimating a disturbance load torque applied to the motor based on a velocity detection value detected by the velocity detecting means and a torque command value prepared by the torque command preparing means, which motor drive device (10) is further provided with at least one of a first filtering means (31) for removing a noise component in the velocity detection value and supplying the velocity detection value to the disturbance load torque estimating means and a second filtering means (32) for removing a noise component in the torque command value and supplying the torque command value to the disturbance load torque estimating means, whereby fluctuation in the torque estimated value is suppressed even if raising the response of the disturbance load torque estimating means.

### BACKGROUND OF THE INVENTION

1. Field of the Invention

The present invention relates to a motor drive device for driving a motor used for a spindle or feed shaft of a machine tool or industrial machine or a motor provided at a robot arm, more particularly relates to a motor drive device provided with a disturbance load torque observer.

2. Description of the Related Art

In a machine tool, robot, industrial machine, etc., in general its spindle, feed shaft, arm, or other driven member is coupled through a ball-screw mechanism or other transmission mechanism to a shaft of a motor and is driven by the motor.

If such a driven member strikes another object, movement or rotation of the driven member is obstructed or the transmission mechanism breaks down and as a result an excessive load is applied to the motor. As a result, the motor breaks down or the driven member is damaged.

To solve this problem, in Japanese Unexamined Patent Publication No. 6-82346, the disturbance torque (load torque) applied to the motor is estimated by a disturbance torque observer based on information relating to the rotational speed and current of the motor, and the estimated disturbance torque is compared with a predetermined reference torque. Furthermore, when the estimated disturbance torque exceeds the reference torque, it is judged that the motor has been subjected to an excessive load and the motor is stopped.

Further, in Japanese Unexamined Patent Publication No. 2007-21991, a disturbance torque estimating means for estimating a disturbance torque based on the torque command of the motor and rotational speed of the motor is disclosed. Furthermore, when it is judged that the rotational speed of the motor has exceeded a reference speed and that the disturbance torque is less than the reference torque, it is judged that an abnormality has occurred.

In Japanese Unexamined Patent Publication No. 6-82346 and Japanese Unexamined Patent Publication No. 2007-21991, the rotational speed of the motor and torque command are directly input into the disturbance torque estimating means etc. For this reason, when the rotational speed and torque command include large noise components, for example, high frequency components, if raising the response of the disturbance torque estimating means etc., the disturbance load torque estimated value may greatly fluctuate. In such a case, it is not possible to accurately judge abnormalities of the motor.

The present invention was made in consideration of this situation and has as its object the provision of a motor drive device free from major fluctuations in the estimated value of the disturbance load even when raising the response of the disturbance torque estimating means.

### SUMMARY OF THE INVENTION

To achieve the above object, according to a first aspect, there is provided a motor drive device including a velocity command preparing means for preparing a velocity command value of a motor, a velocity detecting means for detecting a velocity of a motor, a torque command value preparing means for preparing a torque command value for a motor based on a velocity command value prepared by the velocity command preparing means and a velocity detection value detected by the velocity detecting means, and a disturbance load torque estimating means for estimating a disturbance load torque acting on the motor based on a velocity detection value detected by the velocity detecting means and a torque command value prepared by the torque command preparing means, wherein the motor drive device is further provided with at least one of a first filtering means for removing a noise component in the velocity detection value and a second filtering means for removing a noise component in the torque command value, the velocity detection value from which the noise component has been removed by the first filtering means being supplied to the disturbance load torque estimating means, the torque command value from which the noise component has been removed by the second filtering means being supplied to the disturbance load torque estimating means.

In other words, in the first aspect, the filtering means can cut the noise component, for example, the high frequency component, in the velocity detection value and/or torque command value. For this reason, it is possible to reduce the fluctuation in the disturbance load torque estimated value found by the disturbance load torque estimating means. Thus, even if raising the response of the disturbance torque estimating means, it is possible to suppress major variation in the disturbance load torque estimated value. As a result, it is possible to accurately judge abnormalities of the motor based on the disturbance load torque estimated value.

According to a second aspect, there is provided the first aspect provided with both of the first filtering means and the second filtering means, and a time constant of the first filtering means and a time constant of the second filtering means are made equal.

In other words, in the second aspect, by making the time constants of the two filtering means equal, the time delay can be made equal. For this reason, it is possible to further reduce the fluctuation of the disturbance load torque estimated value found by the disturbance load torque estimating means.

### BRIEF DESCRIPTION OF THE DRAWING

These objects, features, and advantages of the present invention and other objects, features, and advantages will become clearer from the detailed description of typical embodiments of the present invention shown in the attached drawings, wherein

FIG. 1 is a block diagram showing the overall configuration of a motor drive device according to the present invention;

FIG. 2 is a block diagram showing the configuration of an example of a disturbance torque estimating observer;

FIG. 3 is another block diagram showing the surroundings of a disturbance torque estimating observer in the present invention; and

FIG. 4 is a block diagram showing the surroundings of a disturbance torque estimating observer in the related art.

### DETAILED DESCRIPTION

Below, embodiments of the present invention will be explained with reference to the attached drawings. In the following drawings, the same members are assigned the same reference numerals. To facilitate understanding, these drawings are suitably changed in scale.

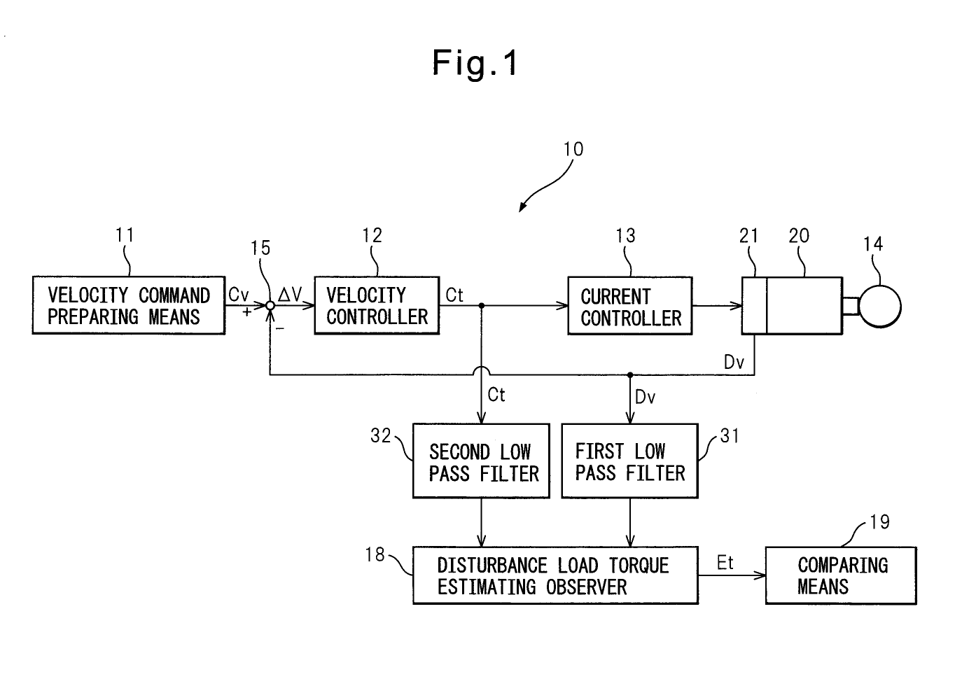

FIG. 1 is a block diagram showing the overall configuration of a motor drive device according to the present invention. The motor drive device 10 shown in FIG. 1 is connected to a motor 20 for driving the driven member 14. The motor 20 in the present invention need not be a servo motor and may also be a DC motor or another type of motor. Further, the motor 20 is provided with a velocity detecting means for detecting the rotational speed of the motor, for example, an encoder 21.

The driven member 14 is coupled through a ball-screw mechanism or other transmission mechanism (not shown) to the shaft of the motor 20 where it is moved or rotated by the rotation of the shaft of the motor 20. The driven member 14 is, for example, a spindle of a machine tool, a feed shaft of a machine tool, an arm of a robot, a feed shaft of an industrial machine, etc.

As shown in FIG. 1, the motor drive device 10 includes a velocity command preparing means 11 for preparing a velocity command value Cv for the motor 20. The velocity command value Cv prepared by the velocity command preparing means 11 is input to the processing element 15. Similarly, the velocity detection value Dv of the motor 20 detected by the encoder 21 is also input to the processing element 15. In the processing element 15, a difference ΔV between the velocity command value Cv and the velocity detection value Dv is prepared.

Further, the motor drive device 10 includes a velocity controller 12 for preparing a torque command value Ct (current command value) for the motor 20 based on the difference ΔV and a current controller 13 controlling the current flowing to the motor 20 based on the torque command value Ct.

As can be seen from FIG. 1, the motor drive device 10 further includes a disturbance load torque estimating observer 18. The torque command value Ct prepared at the velocity controller 12 and the velocity detection value Dv detected by the encoder 21 are input to the disturbance load torque estimating observer 18. The disturbance load torque estimating observer 18 calculates the estimated value Et of the disturbance load torque of the motor 20 based on the torque command value Ct and velocity detection value Dv.

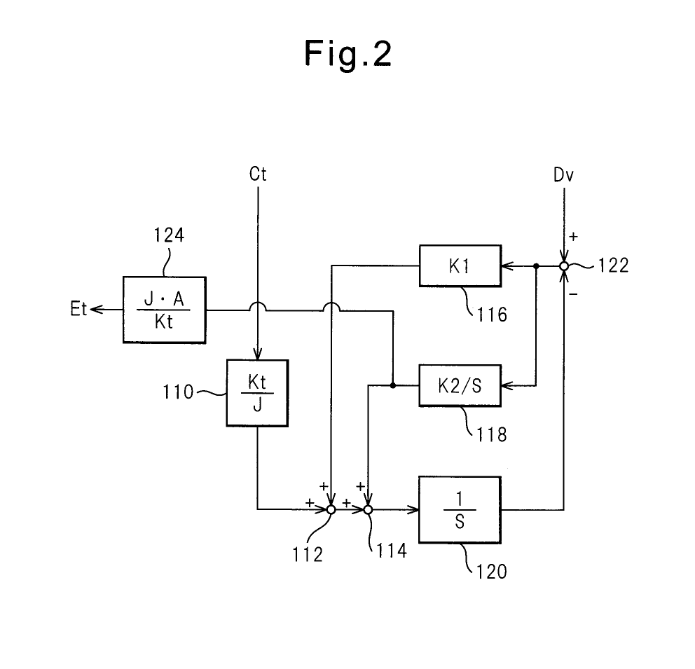

FIG. 2 is a block diagram showing the configuration of an example of a disturbance torque estimating observer. Referring to FIG. 2, an example of the configuration of the disturbance load torque estimating observer 18 will be explained. The torque command value Ct is input as an ordinary current value. The input torque command value Ct is multiplied at the processing element 110 with the constant Kt/J and the result is output to the processing element 112. Here, Kt is the torque constant of the motor 20, while J is the inertia of the motor 20.

In the processing element 112, the feedback from the later explained proportional element 116 is added to the output from the processing element 110. The result is output to the processing element 114. In the processing element 114, the feedback from the later explained integration element 118 is added to the output from the processing element 112. The result is output to the integration element 120. Note that the units of output from the processing element 110, processing element 112, and processing element 114 are acceleration in each case. In the integration element 120, the output from the processing element 114 is integrated to find the estimated rotational velocity Ev of the motor 20 which is then output to the processing element 122.

In the processing element 122, a difference between the output from the integration element 120 and the velocity detection value Dv of the motor 20 detected by the encoder 21 is computed and the difference is fed back to the proportional element 116 and integration element 118. In the proportional element 116, the proportional constant K1 is multiplied with the feedback from the processing element 122. The result is fed back to the processing element 112.

Note that the unit of the proportional constant K1 is sec⁻¹, while the unit of output of the proportional element 116 becomes the acceleration. Further, in the integration element 118, an integration constant K2 is multiplied with the integrated feedback from the processing element 122. The result is fed back or output to the processing element 114 and proportional element 124. Note that the unit of the integration constant K2 is sec⁻², while the unit of output of the integration element 118 becomes the acceleration.

The output of the integration element 118 becomes the estimated acceleration comprised of the disturbance load torque estimated value Et divided by the inertia J of the motor 20. Therefore, in the proportional element 124, J·A/Kt is multiplied with the output from the integration element 118 to convert it to a current value which is then output as the disturbance load torque estimated value Et. Here, A is a coefficient for correction of the estimated acceleration and is a value of 1 or less.

Such a configuration of a disturbance load torque estimating observer 18 is known, so this will not be explained in further detail here. Further, the disturbance load torque estimating observer 18 is not limited to this configuration. It is possible to use a suitable disturbance load torque estimating means able to estimate the disturbance torque applied to the motor 20 based on the current information or torque information (current information) relating to the motor 20 as the disturbance load torque estimating observer 18.

Referring again to FIG. 1, the calculated disturbance load torque estimated value Et is input to the comparing means 19 of the motor drive device 10. The comparing means 19 compares the disturbance load torque estimated value Et and a predetermined reference torque Rt. When the disturbance load torque estimated value Et exceeds the reference torque Rt, it is judged that the load on the motor 20 is normal. On the contrary, when the disturbance load torque estimated value Et is lower than the reference torque Rt, the load on the motor 20 becomes excessively small and it is judged that poor operation of the transmission mechanism, looseness or detachment of the connecting parts of the transmission mechanism and driven member 14, and other abnormalities occur. In this case, the motor 20 is suitably made to stop. Due to this, damage to the driven member 14 or transmission mechanism can be prevented in advance.

As will be shown in FIG. 1, in the present invention, the velocity detection value Dv detected by the encoder 21 passes through the first low pass filter 31 and is input to the disturbance load torque estimating observer 18. Similarly, the torque command value Ct prepared by the velocity controller 12 passes through the second low pass filter 32 and is input to the disturbance load torque estimating observer 18.

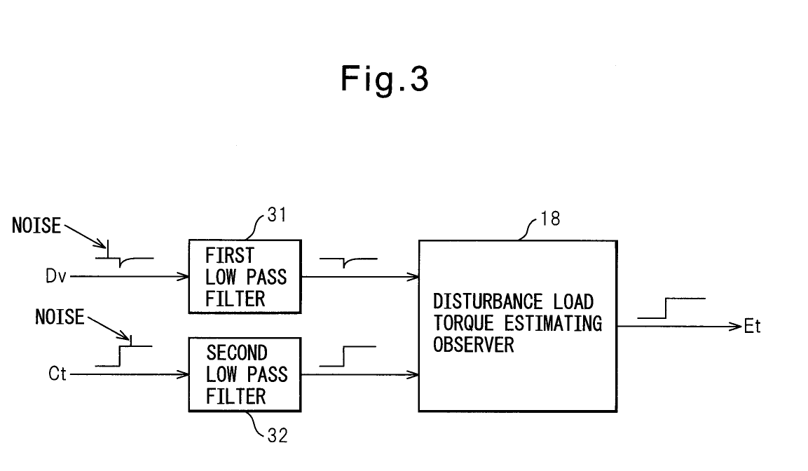

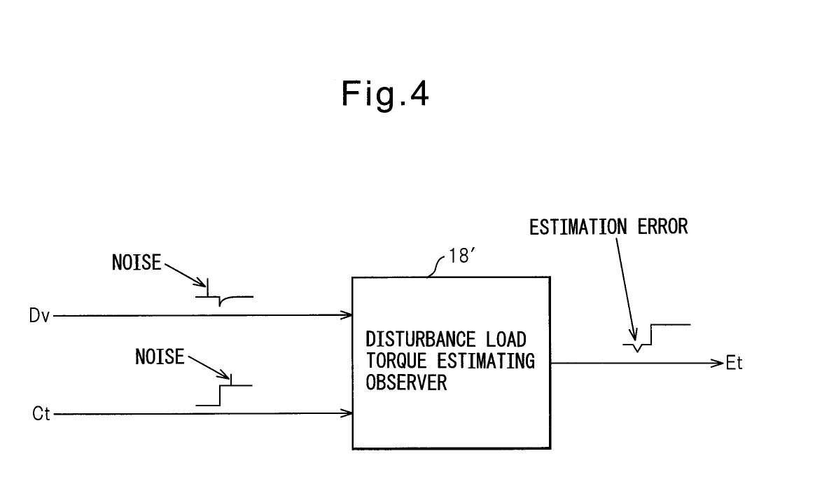

FIG. 3 is another block diagram showing the surroundings of a disturbance torque estimating observer in the present invention, while FIG. 4 is a view of the prior art similar to FIG. 3. As shown in FIG. 3, the velocity detection value Dv and torque command value Ct sometimes include noise components, for example, high frequency components. When these velocity detection value Dv and torque command value Ct pass through the low pass filters 31 and 32, these noise components are cut. In this connection, see the waveforms of the velocity detection value Dv and torque command value Ct between the low pass filters 31 and 32 and the disturbance load torque estimating observer 18.

For this reason, the disturbance load torque estimating observer 18 receives as input a velocity detection value Dv and torque command value Ct not including any noise component. As a result, a disturbance load torque estimated value Et not including any estimation error is output from the disturbance load torque estimating observer 18. In other words, in the present invention, it is possible to reduce the fluctuations in the disturbance load torque estimated value Et calculated by the disturbance load torque estimating observer 18.

As opposed to this, as shown in FIG. 4, when calculating the disturbance load torque estimated value Et based on the velocity detection value Dv and torque command value Ct including noise components, the disturbance load torque estimated value Et includes estimation error. In particular, when raising the response of the disturbance load torque estimating observer 18′ shown in FIG. 4, the estimation error of the disturbance load torque estimated value Et is also increased along with that.

However, in the present invention, the low pass filters 31 and 32 are provided, so even if raising the response of the disturbance load torque estimating observer 18, it is possible to suppress fluctuations in the disturbance load torque estimated value Et. That is, in the present invention, it is possible to accurately find the disturbance load torque estimated value Et, so it becomes possible to accurately judge abnormalities of the motor 20 based on the disturbance load torque estimated value Et. Note that even when either of the low pass filters 31 and 32 is eliminated, it is clear that generally the same effect can be obtained.

However, when the time constant of the first low pass filter 31 and the time constant of the second low pass filter 32 are different, the time delays differ, so the disturbance load torque estimated value Et may include estimation error. Therefore, in the present invention, the time constant of the first low pass filter 31 and the time constant of the second low pass filter 32 are preferably made equal to each other. In this case, it is possible to make the time delay equal, so it is possible to further reduce the fluctuations of the disturbance load torque estimated value Et.

While the present invention was explained using typical embodiments, it will be understood that a person skilled in the art could make the above changes and various other changes, deletions, or additions without departing from the scope of the present invention.

1. A motor drive device including
a velocity command preparing means for preparing a velocity command value of a motor,
a velocity detecting means for detecting a velocity of a motor,
a torque command value preparing means for preparing a torque command value of a torque applied to a motor based on the velocity command value prepared by said velocity command preparing means and a velocity detection value detected by said velocity detecting means, and
a disturbance load torque estimating means for estimating a disturbance load torque applied to said motor based on a velocity detection value detected by said velocity detecting means and a torque command value prepared by said torque command preparing means,
which motor drive device is
further provided with at least one of a first filtering means for removing a noise component in said velocity detection value and a second filtering means for removing a noise component in said torque command value,
said velocity detection value from which said noise component has been removed by said first filtering means being supplied to said disturbance load torque estimating means, said torque command value from which said noise component has been removed by said second filtering means being supplied to said disturbance load torque estimating means.

2. A motor drive device as set forth in claim 1,
further provided with both said first filtering means and said second filtering means, and
a time constant of said first filtering means and a time constant of said second filtering means being made equal to each other.
